(19) United States
(12) Patent Application Publication
(10) Pub. No.: US 2024/0308891 A1
(43) Pub. Date: Sep. 19, 2024

(54) BIOAUGMENTATION SYSTEM FOR DENITRIFICATION OF LANDFILL LEACHATE

(71) Applicant: ZHEJANG A&F University, Hangzhou City (CN)

(72) Inventors: Huajun FENG, Hangzhou City (CN); Yuxiang LIANG, Hangzhou City (CN); Hai XIANG, Hangzhou City (CN); Wei HAN, Hangzhou City (CN); Yangcheng DING, Hangzhou City (CN)

(73) Assignee: Zhejiang A&F University, Hangzhou City (CN)

(21) Appl. No.: 18/595,478

(22) Filed: Mar. 5, 2024

(30) Foreign Application Priority Data
Mar. 17, 2023 (CN) 202310294866.7

(51) Int. Cl. C02F 9/00; C02F 1/00; C02F 1/48; C02F 3/30; C02F 103/06

(52) U.S. Cl. CPC C02F 9/00; C02F 1/48; C02F 3/305; C02F 2001/007; C02F 2103/06

(57) ABSTRACT

Provided is a bioaugmentation system for denitrification of landfill leachate. The bioaugmentation system includes a water collecting pool, an aerobic pool, a weak electrical stimulation anoxic pool, a micro electrical stimulation anoxic pool, and a sedimentation pool, all of which are connected sequentially, wherein a uniform aeration device is arranged at a bottom of the aerobic pool; a first stirring device and a second stirring device are arranged in the weak electrical stimulation anoxic pool and the micro electrical stimulation anoxic pool, respectively; a sludge recycling outlet of the sedimentation pool is connected to a sludge recycling inlet of the aerobic pool through a first external pipeline; a first electrode plate group and a second electrode plate group which are connected to a first power supply and a second power supply respectively are arranged in the weak electrical stimulation anoxic pool and the micro electrical stimulation anoxic pool, respectively.

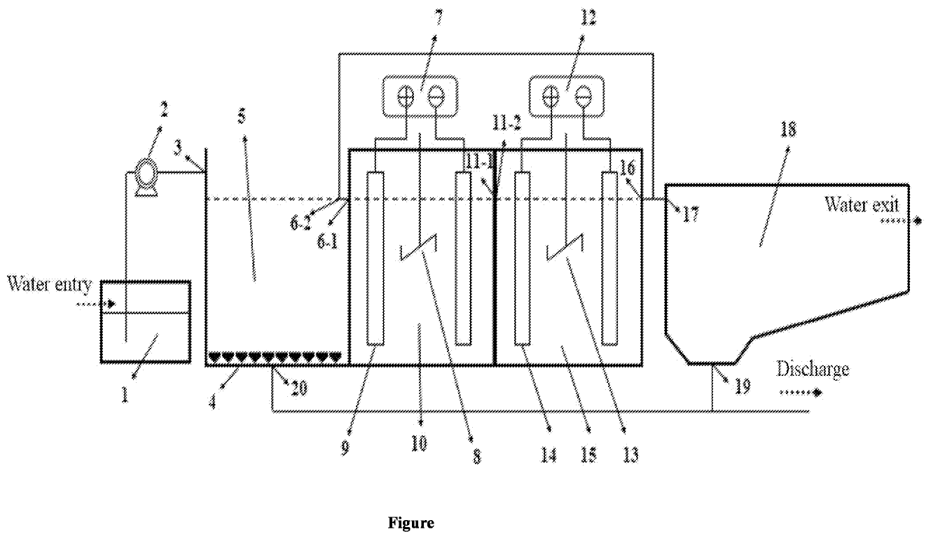

### CROSS-REFERENCE TO RELATED APPLICATION

This patent application claims the benefit and priority of Chinese Patent Application No. 202310294866.7, filed with the China National Intellectual Property Administration on Mar. 17, 2023, the disclosure of which is incorporated by reference herein in its entirety as part of the present application.

### TECHNICAL FIELD

The present disclosure relates to the technical field of landfill leachate purification, and in particular to a bioaugmentation system for denitrification of landfill leachate.

### BACKGROUND

Landfill leachate is a secondary pollutant produced by landfill, which is high-concentration organic landfill leachate, with the main feature of extremely high salinity. The landfill leachate mainly sources from pollutants produced by rain and snow infiltration, external surface water infiltration, groundwater infiltration, garbage itself and microbial decomposition, the composition of which is complex, easy to cause eutrophication of water body and affect ecological stability. The landfill leachate also releases gases such as ammonia and hydrogen sulfide to pollute the environment. Due to the direct use of seawater in some industrial production, the landfill leachate discharged by related industries contains a large quantity of inorganic salt, such as Cl⁻, Na⁺, and Ca²⁺. In addition, a large number of organic substances are produced in the production and manufacturing process of some chemical products (e.g., pesticides, herbicides, pharmaceuticals, and dyes, etc.) and discharged into landfill leachate. Relevant research shows that with the increase of landfill time, the B/C ratio of landfill leachate would gradually decrease to 0.1, and most of the remaining COD (chemical oxygen demand) is difficult to degrade organic substances, which is not conducive to biological denitrification.

Due to the fact that the landfill leachate has the characteristics of high salinity, complex components, and poor biodegradability, how to treat the landfill leachate efficiently, conveniently and environment-friendly has become an urgent problem in recent years. Whether from the perspective of energy consumption reduction or the perspective of ecological environment protection, the reduction energy, and material consumption in sewage treatment is an inevitable goal of industry upgrading. Biological method is still the first choice for landfill leachate treatment. However, due to the high salinity of landfill leachate, conventional microorganisms are prone to the intracellular and extracellular osmotic imbalance and are difficult to survive. Therefore, it is difficult to use the traditional biological methods to meet the effluent quality requirements of landfill leachate quickly. How to enhance the decontamination performance of microorganisms in landfill leachate treatment is a difficult problem in landfill leachate treatment.

CN115072870A discloses a treatment system for achieving heterotrophic and autotrophic synergistic efficient denitrification of sewage. The system includes a raw water pool, an anaerobic pool, an aerobic pool, an anoxic pool, and a sedimentation pool, all of which are connected in sequence. The raw water pool is connected to the anaerobic pool through a first water intake pump and a first water inlet pipe. The raw water pool is connected to the anoxic pool through a second water intake pump and a second water inlet pipe. The bottom of the sedimentation pool is connected to a front end of the anaerobic pool through a sludge recycling pump and a sludge recycling pipe. Fillers could be added to the anoxic pool to enrich anammox. Denitrifying bacteria in the anoxic pool carries out full-denitrification and partial short-range denitrification with an internal carbon source stored in the anaerobic pool and COD in the raw water entering the anoxic pool as carbon sources. The anammox carries out anaerobic ammonia oxidation reaction with nitrite nitrogen generated by short-range denitrification and ammonia nitrogen in the raw water entering the anoxic pool, thus achieving heterotrophic and autotrophic synergistic efficient denitrification. This solution could improve a situation that denitrification efficiency of sewage in the prior art is limited to a reflux ratio of nitration solution, and solve the problem of high treatment cost caused by adding a large number of additional carbon sources.

CN113968657A discloses a landfill leachate treatment system based on electrolytic denitrification and biochemistry. The system includes a lime coagulating sedimentation device, a hardness removal device, a primary electrolytic denitrification device, a biochemical treatment device, a secondary electrolytic purification device, and a secondary coagulating sedimentation device. The lime coagulating sedimentation device is composed of a landfill leachate collection regulating pool, a dosing tank, a coagulation reaction tank, a sedimentation tank, and a supernatant storage tank. A water inlet of the coagulation reaction tank is connected to a water outlet of the landfill leachate collection regulating pool, and a water outlet of the coagulation reaction tank is connected to a water inlet of the sedimentation tank. A supernatant outlet of the sedimentation tank is connected to a water inlet of the supernatant storage tank, and a water outlet of the supernatant storage tank is connected to the hardness removal device. The hardness removal device is composed of a hardness removal reaction tank, a sedimentation separation tank, a solid-liquid separator, and a hardness removal intermediate water pool. A hydrated lime adding tank, a sodium carbonate solution adding tank and a stirrer are also equipped on the hardness removal reaction tank; a water inlet of the hardness removal reaction tank is connected to the water outlet of the supernatant storage tank; a water outlet of the hardness removal reaction tank is connected to a water inlet of the sedimentation separation tank; a water outlet of the sedimentation separation tank is connected to a water inlet of the hardness removal intermediate pool; and a water outlet of the hardness removal intermediate pool is connected to a water inlet of the primary electrolytic denitrification device. The primary electrolytic denitrification device is connected to a water inlet of the biochemical treatment device, and the secondary electrolytic purification device is connected to a water outlet of the biochemical treatment device. The primary electrolytic denitrification device or the secondary electrolytic purification device is composed of an electrolytic machine, a degassing tank, a pickling descaling device, and a reduction tank. A water inlet of the electrolytic machine of the primary electrolytic denitrification device communicates with the hardness removal device, and a water outlet of the electrolytic machine is connected to a water inlet of the degassing tank. A water outlet of the degassing tank is connected to a water inlet of the reduction tank, and the degassing tank is also provided with a circulation port which is connected to a water inlet pipe of the electrolytic machine through a pipeline and a circulating water pump. The biochemical treatment device is one of the combinations as follows: an anaerobic pool, an anoxic pool, an aerobic pool, a sedimentation separation tank and a biochemical water-producing intermediate pool, all of which are connected in sequence; or a primary anaerobic pool, a primary aerobic pool, a secondary anaerobic pool, a secondary aerobic pool and a biochemical water-producing intermediate pool, all of which are connected in sequence; or an aerobic pool, an aerated biological filter, a denitrification deep bed filter and a biochemical water-producing intermediate pool, all of which are connected in sequence. The secondary coagulation and sedimentation device includes a pH adjusting pool, a coagulation pool, a coagulation aid pool, a sedimentation pool and an intermediate pool, all of which are connected in sequence. The top of the sedimentation pool is provided with a supernatant outlet which is connected to the water inlet of the intermediate pool. The bottom of the sedimentation pool is provided with a sludge outlet which is connected to a sludge pump. This solution could solve the problems of excessive ammonia nitrogen in drainage and concentrated solution.

There are at least the following problems in the prior art:
1. The reduction process of nitrate nitrogen and the biological activity enhancement of anammox are not separated, leading to the low denitrification efficiency in landfill leachate treatment.
2. The applied voltage is not differentiated according to the conductivity, leading to the waste of electric energy.

### SUMMARY

In order to solve the technical problems in the prior art, a bioaugmentation system for denitrification of landfill leachate is provided in the present disclosure, including a water collecting pool, an aerobic pool, a weak electrical stimulation anoxic pool, a micro electrical stimulation anoxic pool, and a sedimentation pool, all of which are connected in sequence, wherein a uniform aeration device is arranged at a bottom of the aerobic pool; a first stirring device and a second stirring device are arranged in the weak electrical stimulation anoxic pool and the micro electrical stimulation anoxic pool, respectively; a sludge recycling outlet of the sedimentation pool is connected to a sludge recycling inlet of the aerobic pool through a first external pipeline; electrode plates in the first electrode plate group and the second electrode plate group each have a cuboid structure, a spacing between an anode and a cathode of each of the electrode plates is greater than 0.5 m, and cross-sectional area of a single electrode plate accounts for at least 50% of that of each of the weak electrical stimulation anoxic pool and the micro electrical stimulation anoxic pool; a first electrode plate group that is connected to a first power supply is arranged in the weak electrical stimulation anoxic pool, a second electrode plate group that is connected to a second power supply is arranged in the micro electrical stimulation anoxic pool, and different voltages are applied according to the type of a sludge pool and actual conductivity in the landfill leachate treatment process; a voltage applied to the weak electrical stimulation anoxic pool is in a range of 1.0-2.0 V, and a voltage applied to the micro electrical stimulation anoxic pool is in a range of 0.2-0.6 V; the first power supply and the second power supply each are a direct-current (DC) regulated power supply; electrode plates in the first electrode plate group and the second electrode plate group each are a graphite electrode plate; aerobic sludge with nitrifying bacteria as dominant strain is provided in the aerobic pool; anoxic sludge with denitrifying bacteria as dominant strain is provided in the weak electrical stimulation anoxic pool; and anoxic sludge with anammox bacteria as dominant strain is provided in the micro electrical stimulation anoxic pool. The salt tolerance and decontamination performance of the microorganisms are enhanced by applying different DC voltages, so as to achieve the purpose of efficiently removing nitrogen pollutant in the landfill leachate. The problem of low denitrification efficiency in efficient and convenient treatment of landfill leachate could be solved, and electric energy output could be saved to the greatest extent while ensuring the pollutant removal efficiency.

Provided is a bioaugmentation system for denitrification of landfill leachate, which includes a water collecting pool, an aerobic pool, a weak electrical stimulation anoxic pool, a micro electrical stimulation anoxic pool, and a sedimentation pool, all of which are connected in sequence, wherein
a uniform aeration device is arranged at a bottom of the aerobic pool;
a first stirring device and a second stirring device are arranged in the weak electrical stimulation anoxic pool and the micro electrical stimulation anoxic pool, respectively;
a sludge recycling outlet of the sedimentation pool is connected to a sludge recycling inlet of the aerobic pool through a first external pipeline;
a first electrode plate group that is connected to a first power supply is arranged in the weak electrical stimulation anoxic pool, a second electrode plate group that is connected to a second power supply is arranged in the micro electrical stimulation anoxic pool, and different voltages are applied according to the type of a sludge pool and actual conductivity in the landfill leachate treatment process; a voltage applied to the weak electrical stimulation anoxic pool is in a range of 1.0-2.0 V, and a voltage applied to the micro electrical stimulation anoxic pool is in a range of 0.2-0.6 V;
electrode plates in the first electrode plate group and the second electrode plate group each have a cuboid structure, a spacing between an anode and a cathode of each of the electrode plates is greater than 0.5 m, and cross-sectional area of a single electrode plate accounts for at least 50% of that of each of the weak electrical stimulation anoxic pool and the micro electrical stimulation anoxic pool;
the first power supply and the second power supply each are a direct-current (DC) regulated power supply;
electrode plates in the first electrode plate group and the second electrode plate group each are a graphite electrode plate;
aerobic sludge with nitrifying bacteria as dominant strain is provided in the aerobic pool; anoxic sludge with denitrifying bacteria as dominant strain is provided in the weak electrical stimulation anoxic pool; and anoxic sludge with anammox bacteria as dominant strain is provided in the micro electrical stimulation anoxic pool.

In some embodiments, the spacing between an anode and a cathode in the first electrode plate group is in a range of 0.5-1.0 m, and the cross-sectional area of the single electrode plate accounts for 60-70% of that of each of the weak electrical stimulation anoxic pool and the micro electrical stimulation anoxic pool.

In some embodiments, potentials of the anode and the cathode each are ½ that of DC voltage.

In some embodiments, a DC voltage applied to each of the weak electrical stimulation anoxic pool and the micro electrical stimulation anoxic pool is jointly determined according to the type of the sludge pool and conductivity of the landfill leachate, specifically as follows:
for the weak electrical stimulation anoxic pool:
under the condition that conductivity of the landfill leachate is less than 1×10⁴ μs/cm, the DC voltage applied is in a range of 1.6 V to 2.0 V, an electric field intensity is in a range of 1.6 V/m to 4.0 V/m, an anode potential is in a range of 0.8 V to 1.0 V, and a cathode potential is in a range of −0.8 V to −1.0 V;
under the condition that conductivity of the landfill leachate is greater than or equal to 1×10⁴ μs/cm, the DC voltage applied is in a range of 1.0 V to 1.6 V, the electric field intensity is in a range of 1.0 V/m to 3.2 V/m, an anode potential is in a range of 0.5 V to 0.8 V, and a cathode potential is in a range of −0.5 V to −0.8 V;
for the micro electrical stimulation anoxic pool:
under the condition that conductivity of the landfill leachate is less than 1×10⁴ μs/cm, the DC voltage applied is in a range of 0.4 V to 0.6 V, an electric field intensity is in a range of 0.4 V/m to 1.2 V/m, an anode potential is in a range of 0.2 V to 0.3 V, and a cathode potential is in a range of −0.2 V to −0.3 V;
under the condition that the conductivity of the landfill leachate is greater than or equal to 1×10⁴ μs/cm, the DC voltage applied is in a range of 0.2 V to 0.4 V, an electric field intensity is in a range of 0.2 V/m to 0.8 V/m, an anode potential is in a range of 0.1 V to 0.2 V, and a cathode potential is in a range of −0.1 V to −0.2 V.

A higher conductivity represents a higher the electron transfer efficiency in the solution, so a more satisfactory effect could be achieved by applying a lower DC voltage. In view of economy, lower voltage is adopted. The electric field intensity=voltage/electrode spacing.

In some embodiments, the water collecting pool is provided with a water inlet of the water collecting pool at an upper portion and an emptying valve at a bottom.

In some embodiments, the water collecting pool is connected with a water inlet of the aerobic pool through a water pump and a second external pipeline, and a water outlet of the aerobic pool is connected with a water inlet of the weak electrical stimulation anoxic pool through a pipeline.

In some embodiments, the water inlet of the weak electrical stimulation anoxic pool is arranged at an upper portion of an inner wall at one side of the weak electrical stimulation anoxic pool, and a water outlet of the weak electrical stimulation anoxic pool is arranged at an upper portion of an inner wall at a side opposite to the one side; and a water inlet of the micro electrical stimulation anoxic pool is arranged at an upper portion of an inner wall at one side of the micro electrical stimulation anoxic pool, at an upper portion of an inner wall at a side opposite to the one side, arranged is a water outlet of the micro electrical stimulation anoxic pool.

In some embodiments, the water outlet of the micro electrical stimulation anoxic pool is further connected with the water inlet of the weak electrical stimulation anoxic pool through another pipeline.

In some embodiments, the aerobic pool and the weak electrical stimulation anoxic pool are closely connected with each other, and share a same side wall; and a water outlet of the aerobic pool also acts as a water inlet of the weak electrical stimulation anoxic pool; and
the weak electrical stimulation anoxic pool and the micro electrical stimulation anoxic pool are closely connected with each other and share a same side wall; and a water outlet of the weak electrical stimulation anoxic pool also acts as a water inlet of the micro electrical stimulation anoxic pool.

In some embodiments, the sludge recycling outlet is arranged at a bottom of the sedimentation pool.

In some embodiments, in the aerobic sludge provided in the aerobic pool, nitrifying bacteria as dominant strain account for 60-80%; in the anoxic sludge provided in the weak electrical stimulation anoxic pool, denitrifying bacteria as dominant strain account for 60-80%; and in the anoxic sludge provided in the micro electrical stimulation anoxic pool, anammox bacteria as dominant strain account for 60-80%.

Compared with the prior art, embodiments of the present disclosure have beneficial effects as follows:
1. According to a bioaugmentation system for denitrification of landfill leachate of the present disclosure, electrical stimulation and biological treatment are combined to innovatively classify the anoxic pools into a weak electrical stimulation anoxic pool and a micro electrical stimulation anoxic pool. The former weak electrical stimulation is intended to accelerate the reduction process of nitrate nitrogen by providing electrons to the water body, and the latter micro electrical stimulation is intended to enhance the biological activity of anammox bacteria, improve contents of the extracellular polymer protein and polysaccharide of microorganisms and increase the intracellular compatible solute content of microorganisms, thereby improving the biological activity and reproduction rate of microorganisms in the complex water quality environment of landfill leachate, so as to solve the problem of low denitrification efficiency in efficient and convenient treatment of landfill leachate.
2. According to the method for treating the landfill leachate of the present disclosure, the DC voltage of the electric stimulation bio-pool is determined according to the conductivity of the landfill leachate, and the low DC voltage is used for stimulation in the landfill leachate with high conductivity, while the high voltage is used for stimulation in the landfill leachate with low conductivity, so that the electric energy output is saved to the greatest extent while ensuring the pollutant removal efficiency.

### BRIEF DESCRIPTION OF THE DRAWINGS

FIGURE shows a schematic diagram of a bioaugmentation system for denitrification of landfill leachate according to one embodiment of the present disclosure.

In the drawing, 1 represents water collecting pool; 2 represents water pump; 3 represents water inlet of aerobic pool; 4 represents aeration device; 5 represents aerobic pool; 6-1 represents water outlet of aerobic pool; 6-2 represents water inlet of weak electrical stimulation anoxic pool; 7 represents first power supply; 8 represents first stirring device; 9 represents first electrode plate group; 10 represents weak electrical stimulation anoxic pool; 11-1 represents water outlet of weak electrical stimulation anoxic pool; 11-2 represents water inlet of micro electrical stimulation anoxic pool; 12 represents second power supply; 13 represents second stirring device; 14 represents second electrode plate group; 15 represents micro electrical stimulation anoxic pool; 16 represents water outlet of micro electrical stimulation anoxic pool; 17 represents water inlet of sedimentation pool; 18 represents sedimentation pool; 19 represents sludge recycling outlet; 20 represents sludge recycling inlet.

### DETAILED DESCRIPTION OF THE EMBODIMENTS

The embodiments of the present disclosure are further described below in detail with reference to FIGURE.

The present disclosure provides a bioaugmentation system for denitrification of landfill leachate, including a water collecting pool 1, an aerobic pool 5, a weak electrical stimulation anoxic pool 10, a micro electrical stimulation anoxic pool 15, and a sedimentation pool 18, all of which are connected in sequence,
wherein a uniform aeration device 4 is arranged at a bottom of the aerobic pool 5;
a first stirring device 8 and a second stirring device 13 are arranged in the weak electrical stimulation anoxic pool 10 and the micro electrical stimulation anoxic pool 15, respectively.
a sludge recycling outlet 19 of the sedimentation pool 18 is connected to a sludge recycling inlet 20 of the aerobic pool 5 through a first external pipeline;
a first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V;
electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15;
the first power supply 7 and the second power supply 12 each are a direct-current (DC) regulated power supply;
the electrode plates in the first electrode plate group 9 and the second electrode plate group 14 each are a graphite electrode plate;
aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

According to one specific embodiment of the present disclosure, the spacing between an anode and a cathode in the first electrode plate group is in a range of 0.5-1.0 m, and the cross-sectional area of the single electrode plate accounts for 60-70% of that of each of the weak electrical stimulation anoxic pool 10 and the micro electrical stimulation anoxic pool 15.

According to one specific embodiment of the present disclosure, potentials of the anode and the cathode each are ½ of a DC voltage.

According to one specific embodiment of the present disclosure, the DC voltage applied to each of the weak electrical stimulation anoxic pool 10 and the micro electrical stimulation anoxic pool 15 is jointly determined according to the type of a sludge pool and conductivity of the landfill leachate, specifically as follows:
for the weak electrical stimulation anoxic pool 10:
under the condition that the conductivity of the landfill leachate is less than 1×10⁴ μs/cm, the DC voltage applied is in a range of 1.6 V to 2.0 V, an electric field intensity is in a range of 1.6 V/m to 4.0 V/m, an anode potential is in a range of 0.8 V to 1.0 V, and a cathode potential is in a range of −0.8 V to −1.0 V; and
under the condition that conductivity of the landfill leachate is greater than or equal to 1× 10⁴ μs/cm, the DC voltage applied is in a range of 1.0 V to 1.6 V, the electric field intensity is in a range of 1.0 V/m to 3.2 V/m, the anode potential is in a range of 0.5 V to 0.8 V, and the cathode potential is in a range of −0.5 V to −0.8 V;
for the micro electrical stimulation anoxic pool 15:
under the condition that the conductivity of the landfill leachate is less than 1×10⁴ μs/cm, the DC voltage applied is in a range of 0.4 V to 0.6 V, an electric field intensity is in a range of 0.4 V/m to 1.2 V/m, an anode potential is in a range of 0.2 V to 0.3 V, and a cathode potential is in a range of −0.2 V to −0.3 V; and
under the condition that the conductivity of the landfill leachate is greater than or equal to 1×10⁴ μs/cm, the DC voltage applied is in a range of 0.2 V to 0.4 V, the electric field intensity is in a range of 0.2 V/m to 0.8 V/m, the anode potential is in a range of 0.1 V to 0.2 V, and the cathode potential is in a range of −0.1 V to −0.2 V.

According to one specific embodiment of the present disclosure, the water collecting pool 1 is provided with a water inlet of the water collecting pool 1 at an upper portion and an emptying valve at a bottom.

According to one specific embodiment of the present disclosure, the water collecting pool 1 is connected with a water inlet 3 of the aerobic pool through a water pump 2 and a second external pipeline, and a water outlet 6-1 of the aerobic pool is connected with a water inlet 6-2 of the weak electrical stimulation anoxic pool through a pipeline.

According to one specific embodiment of the present disclosure, the water inlet 6-2 of the weak electrical stimulation anoxic pool is arranged at an upper portion of an inner wall at one side of the weak electrical stimulation anoxic pool 10, and water outlet 11-1 of the weak electrical stimulation anoxic pool is arranged at an upper portion of an inner wall at a side opposite to the one side; and a water inlet 11-2 of the micro electrical stimulation anoxic pool is arranged at an upper portion of an inner wall at one side of the micro electrical stimulation anoxic pool 15, and a water outlet 16 of the micro electrical stimulation anoxic pool is arranged at an upper portion of an inner wall at a side opposite to the one side.

According to one specific embodiment of the present disclosure, the water outlet 16 of the micro electrical stimulation anoxic pool is further connected with the water inlet 6-2 of the weak electrical stimulation anoxic pool through another pipeline.

According to one specific embodiment of the present disclosure, the aerobic pool 5 and the weak electrical stimulation anoxic pool 10 are closely connected with each other, and share a same side wall; and a water outlet 6-1 of the aerobic pool also acts as a water inlet 6-2 of the weak electrical stimulation anoxic pool; and the weak electrical stimulation anoxic pool 10 and the micro electrical stimulation anoxic pool 15 are closely connected with each other and share a same side wall; and a water outlet 11-1 of the weak electrical stimulation anoxic pool also acts as a water inlet 11-2 of the micro electrical stimulation anoxic pool.

According to one specific embodiment of the present disclosure, the sludge recycling outlet 19 is arranged at a bottom of the sedimentation pool 18.

According to one specific embodiment of the present disclosure, in the aerobic sludge provided in the aerobic pool 5, nitrifying bacteria as dominant strain account for 60-80%; in the anoxic sludge provided in the weak electrical stimulation anoxic pool 10, denitrifying bacteria as dominant strain account for 60-80%; and in the anoxic sludge provided in the micro electrical stimulation anoxic pool 15, anammox bacteria as dominant strain account for 60-80%.

In some embodiments, the operation process of the system is as follows:
sludge passes through the water collecting pool 1, the aerobic pool 5, the weak electrical stimulation anoxic pool 10, the micro electrical stimulation anoxic pool 15, and the sedimentation pool 18 in sequence. The water collecting pool 1 is configured to even the influent quality and adjust the water flow. After the landfill leachate enters the aerobic pool 5, ammonia nitrogen is nitrated by nitrifying bacteria to gradually generate nitrate nitrogen, then the landfill leachate enters the weak electrical stimulation anoxic pool 10, and most nitrate nitrogen in the landfill leachate is reduced by the denitrifying bacteria into nitrogen gas, which is discharged. After passing through the micro electrical stimulation anoxic pool 15, non-completely oxidized ammonia nitrogen in the landfill leachate is subjected to anaerobic ammonia oxidation process to completely remove the ammonia nitrogen. Before entering the sedimentation pool 18, the effluent is recycled to the weak electrical stimulation anoxic pool 10 to thoroughly remove the nitrate nitrogen that is not completely removed previously. Finally, the effluent enters the sedimentation pool 18, the supernatant is discharged, while the sludge could be recycled for secondary utilization or directly discharged.

### Example 1

According to one specific embodiment of the present disclosure, a bioaugmentation system for nitrogen denitrification of landfill leachate of the present disclosure is described in detail below.

Provided is a bioaugmentation system for denitrification of landfill leachate, consisting of a water collecting pool 1, an aerobic pool 5, a weak electrical stimulation anoxic pool 10, a micro electrical stimulation anoxic pool 15, and a sedimentation pool 18, all of which are connected in sequence.

A uniform aeration device 4 is arranged at a bottom of the aerobic pool 5.

A first stirring device 8 and a second stirring device 13 are arranged in the weak electrical stimulation anoxic pool 10 and the micro electrical stimulation anoxic pool 15, respectively.

A sludge recycling outlet 19 of the sedimentation pool 18 is connected to a sludge recycling inlet 20 of the aerobic pool 5 through an external pipeline.

A first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V.

Electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15. The first power supply 7 and the second power supply 12 each are a direct-current (DC) regulated power supply.

The electrode plates in the first electrode plate group 9 and the second electrode plate group 14 each are a graphite electrode plate.

Aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

### Example 2

Provided is a bioaugmentation system for denitrification of landfill leachate, consisting of a water collecting pool 1, an aerobic pool 5, a weak electrical stimulation anoxic pool 10, a micro electrical stimulation anoxic pool 15, and a sedimentation pool 18, all of which are connected in sequence.

A uniform aeration device 4 is arranged at a bottom of the aerobic pool 5.

A first stirring device 8 and a second stirring device 13 are arranged in the weak electrical stimulation anoxic pool 10 and the micro electrical stimulation anoxic pool 15, respectively.

A sludge recycling outlet 19 of the sedimentation pool 18 is connected to a sludge recycling inlet 20 of the aerobic pool 5 through an external pipeline.

A first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V.

Electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15.

The first power supply 7 and the second power supply 12 each are a direct-current (DC) regulated power supply.

Electrode plates in the first electrode plate group 9 and the second electrode plate group 14 each are a graphite electrode plate.

Aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

The DC voltage applied to each of the weak electrical stimulation anoxic pool 10 and the micro electrical stimulation anoxic pool 15 is jointly determined according to the type of a sludge pool and the conductivity of the landfill leachate, specifically as follows.

For the weak electrical stimulation anoxic pool 10:
under the condition that conductivity of the landfill leachate is less than 1×10⁴ μs/cm, the DC voltage applied is in a range of 1.6 V to 2.0 V, an electric field intensity is in a range of 1.6 V/m to 4.0 V/m, an anode potential is in a range of 0.8 V to 1.0 V, and a cathode potential is in a range of −0.8 V to −1.0 V;
under the condition that conductivity of the landfill leachate is greater than or equal to 1×10⁴ μs/cm, the DC voltage applied is in a range of 1.0 V to 1.6 V, the electric field intensity is in a range of 1.0 V/m to 3.2 V/m, an anode potential is in a range of 0.5 V to 0.8 V, and a cathode potential is in a range of −0.5 V to −0.8 V.

For the micro electrical stimulation anoxic pool 15:
under the condition that conductivity of the landfill leachate is less than 1×10⁴ μs/cm, the DC voltage applied is in a range of 0.4 V to 0.6 V, an electric field intensity is in a range of 0.4 V/m to 1.2 V/m, an anode potential is in a range of 0.2 V to 0.3 V, and a cathode potential is in a range of −0.2 V to −0.3 V;
under the condition that the conductivity of the landfill leachate is greater than or equal to 1×10⁴ μs/cm, the DC voltage applied is in a range of 0.2 V to 0.4 V, an electric field intensity is in a range of 0.2 V/m to 0.8 V/m, an anode potential is in a range of 0.1 V to 0.2 V, and a cathode potential is in a range of −0.1 V to −0.2 V.

### Example 3

Provided is a bioaugmentation system for denitrification of landfill leachate, consisting of a water collecting pool 1, an aerobic pool 5, a weak electrical stimulation anoxic pool 10, a micro electrical stimulation anoxic pool 15, and a sedimentation pool 18, all of which are connected in sequence.

A uniform aeration device 4 is arranged at a bottom of the aerobic pool 5.

A first stirring device 8 and a second stirring device 13 are arranged in the weak electrical stimulation anoxic pool 10 and the micro electrical stimulation anoxic pool 15, respectively.

A sludge recycling outlet 19 of the sedimentation pool 18 is connected to a sludge recycling inlet 20 of the aerobic pool 5 through an external pipeline.

A first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V.

Electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15.

The first power supply 7 and the second power supply 12 each are a direct-current (DC) regulated power supply.

Electrode plates in the first electrode plate group 9 and the second electrode plate group 14 each are a graphite electrode plate.

Aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

The spacing between an anode and a cathode in the first electrode plate group is in a range of 0.5-1.0 m, and the cross-sectional area of the single electrode plate accounts for 60-70% of that of each of the weak electrical stimulation anoxic pool 10 and the micro electrical stimulation anoxic pool 15.

### Example 4

According to one specific embodiment of the present disclosure, a bioaugmentation system for denitrification of landfill leachate of the present disclosure is described in detail below.

Provided is a bioaugmentation system for denitrification of landfill leachate, consisting of a water collecting pool 1, an aerobic pool 5, a weak electrical stimulation anoxic pool 10, a micro electrical stimulation anoxic pool 15, and a sedimentation pool 18, all of which are connected in sequence.

A uniform aeration device 4 is arranged at a bottom of the aerobic pool 5.

A first stirring device 8 and a second stirring device 13 are arranged in the weak electrical stimulation anoxic pool 10 and the micro electrical stimulation anoxic pool 15, respectively.

A sludge recycling outlet 19 of the sedimentation pool 18 is connected to a sludge recycling inlet 20 of the aerobic pool 5 through an external pipeline.

A first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V.

Electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15.

The first power supply 7 and the second power supply 12 each are a direct-current (DC) regulated power supply.

Electrode plates in the first electrode plate group 9 and the second electrode plate group 14 each are a graphite electrode plate.

Aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

The water collecting pool 1 is provided with a water inlet of the water collecting pool 1 at an upper portion and an emptying valve at the bottom.

The water collecting pool 1 is connected to a water inlet 3 of the aerobic pool through a water pump 2 and an external pipeline, and a water outlet 6-1 of the aerobic pool is connected to a water inlet 6-2 of the weak electrical stimulation anoxic pool through a pipeline.

### Example 5

According to one specific embodiment of the present disclosure, a bioaugmentation system for denitrification of landfill leachate of the present disclosure is described in detail below.

Provided is a bioaugmentation system for denitrification of landfill leachate, consisting of a water collecting pool 1, an aerobic pool 5, a weak electrical stimulation anoxic pool 10, a micro electrical stimulation anoxic pool 15, and a sedimentation pool 18, all of which are connected in sequence.

A uniform aeration device 4 is arranged at a bottom of the aerobic pool 5.

A first stirring device 8 and a second stirring device 13 are arranged in the weak electrical stimulation anoxic pool 10 and the micro electrical stimulation anoxic pool 15, respectively.

A sludge recycling outlet 19 of the sedimentation pool 18 is connected to a sludge recycling inlet 20 of the aerobic pool 5 through an external pipeline.

A first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V.

Electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15.

The first power supply 7 and the second power supply 12 each are a direct-current (DC) regulated power supply.

Electrode plates in the first electrode plate group 9 and the second electrode plate group 14 each are a graphite electrode plate.

Aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

A water inlet 6-2 of the weak electrical stimulation anoxic pool is arranged at an upper portion of an inner wall at one side of the weak electrical stimulation anoxic pool 10, a water outlet 11-1 of the weak electrical stimulation anoxic pool is arranged at an upper portion of an inner wall at a side opposite to the one side. A water inlet 11-2 of the micro electrical stimulation anoxic pool is arranged at an upper portion of an inner wall at one side of the micro electrical stimulation anoxic pool 15, and a water outlet 16 of the micro electrical stimulation anoxic pool is arranged at an upper portion of an inner wall at a side opposite to the one side.

The water outlet 16 of the micro electrical stimulation anoxic pool is further connected to the water inlet 6-2 of the weak electrical stimulation anoxic pool through another pipeline.

### Example 6

According to one specific embodiment of the present disclosure, a bioaugmentation system for denitrification of landfill leachate of the present disclosure is described in detail below.

Provided is a bioaugmentation system for denitrification of landfill leachate, consisting of a water collecting pool 1, an aerobic pool 5, a weak electrical stimulation anoxic pool 10, a micro electrical stimulation anoxic pool 15, and a sedimentation pool 18, all of which are connected in sequence.

A uniform aeration device 4 is arranged at a bottom of the aerobic pool 5.

A first stirring device 8 and a second stirring device 13 are arranged in the weak electrical stimulation anoxic pool 10 and the micro electrical stimulation anoxic pool 15, respectively.

A sludge recycling outlet 19 of the sedimentation pool 18 is connected to a sludge recycling inlet 20 of the aerobic pool 5 through an external pipeline.

A first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V.

Electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15. The first power supply 7 and the second power supply 12 each are a DC regulated power supply.

Electrode plates in the first electrode plate group 9 and the second electrode plate group 14 each are a graphite electrode plate.

Aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

The aerobic pool 5 and the weak electrical stimulation anoxic pool 10 are closely connected with each other, and share a same side wall; and a water outlet 6-1 of the aerobic pool also acts as the water inlet 6-2 of the weak electrical stimulation anoxic pool. The weak electrical stimulation anoxic pool 10 and the micro electrical stimulation anoxic pool 15 are closely connected with each other, and share a same side wall; and a water outlet 11-1 of the weak electrical stimulation anoxic pool also acts as the water inlet 11-2 of the micro electrical stimulation anoxic pool.

### Example 7

According to one specific embodiment of the present disclosure, a bioaugmentation system for denitrification of landfill leachate of the present disclosure is described in detail below.

Provided is a bioaugmentation system for denitrification of landfill leachate, consisting of a water collecting pool 1, an aerobic pool 5, a weak electrical stimulation anoxic pool 10, a micro electrical stimulation anoxic pool 15, and a sedimentation pool 18, all of which are connected in sequence.

A uniform aeration device 4 is arranged at a bottom of the aerobic pool 5.

A first stirring device 8 and a second stirring device 13 are arranged in the weak electrical stimulation anoxic pool 10 and the micro electrical stimulation anoxic pool 15, respectively.

A sludge recycling outlet 19 of the sedimentation pool 18 is connected to a sludge recycling inlet 20 of the aerobic pool 5 through an external pipeline.

A first electrode plate group 9 that is connected to a first power supply 7 is arranged in the weak electrical stimulation anoxic pool 10, a second electrode plate group that is connected to a second power supply 12 is arranged in the micro electrical stimulation anoxic pool 15, and different voltages are applied according to the type of a sludge pool and actual conductivity in the landfill leachate treatment process; a voltage applied to the weak electrical stimulation anoxic pool 10 is in a range of 1.0-2.0 V, and a voltage applied to the micro electrical stimulation anoxic pool 15 is in a range of 0.2-0.6 V.

Electrode plates in the first electrode plate group 9 and the second electrode plate group 14 each have a cuboid structure, a spacing between an anode and a cathode of each of the electrode plates is greater than 0.5 m, and cross-sectional area of a single electrode plate accounts for at least 50% of that of each of the weak electrical stimulation anoxic pool 10 and the micro electrical stimulation anoxic pool 15.

The first power supply 7 and the second power supply 12 each are a direct-current (DC) regulated power supply.

Electrode plates in the first electrode plate group 9 and the second electrode plate group 14 each are a graphite electrode plate.

Aerobic sludge with nitrifying bacteria as dominant strain is provided in the aerobic pool 5; anoxic sludge with denitrifying bacteria as dominant strain is provided in the weak electrical stimulation anoxic pool 10; and anoxic sludge with anammox bacteria as dominant strain is provided in the micro electrical stimulation anoxic pool 15.

The spacing between an anode and a cathode in the first electrode plate group is in a range of 0.5-1.0 m, and the cross-sectional area of the single electrode plate accounts for 60-70% of that of each of the weak electrical stimulation anoxic pool 10 and the micro electrical stimulation anoxic pool 15.

A DC voltage applied to each of the weak electrical stimulation anoxic pool 10 and the micro electrical stimulation anoxic pool 15 is jointly determined according to the type of the sludge pool and conductivity of the landfill leachate, specifically as follows:
for the weak electrical stimulation anoxic pool 10:
under the condition that conductivity of the landfill leachate is less than 1×10⁴ μs/cm, the DC voltage applied is in a range of 1.6 V to 2.0 V, an electric field intensity is in a range of 1.6 V/m to 4.0 V/m, an anode potential is in a range of 0.8 V to 1.0 V, and a cathode potential is in a range of −0.8 V to −1.0 V;
under the condition that conductivity of the landfill leachate is greater than or equal to 1× 10⁴ μs/cm, the DC voltage applied is in a range of 1.0 V to 1.6 V, the electric field intensity is in a range of 1.0 V/m to 3.2 V/m, an anode potential is in a range of 0.5 V to 0.8 V, and a cathode potential is in a range of −0.5 V to −0.8 V;
for the micro electrical stimulation anoxic pool 15:
under the condition that conductivity of the landfill leachate is less than 1×10⁴ μs/cm, the DC voltage applied is in a range of 0.4 V to 0.6 V, an electric field intensity is in a range of 0.4 V/m to 1.2 V/m, an anode potential is in a range of 0.2 V to 0.3 V, and a cathode potential is in a range of −0.2 V to −0.3 V;
under the condition that the conductivity of the landfill leachate is greater than or equal to 1×10⁴ μs/cm, the DC voltage applied is in a range of 0.2 V to 0.4 V, an electric field intensity is in a range of 0.2 V/m to 0.8 V/m, an anode potential is in a range of 0.1 V to 0.2 V, and a cathode potential is in a range of −0.1 V to −0.2 V.

The water collecting pool 1 is provided with a water inlet of the water collecting pool 1 at an upper portion and an emptying valve at the bottom.

The water collecting pool 1 is connected to a water inlet 3 of the aerobic pool through a water pump 2 and an external pipeline, and a water outlet 6-1 of the aerobic pool is connected to a water inlet 6-2 of the weak electrical stimulation anoxic pool through a pipeline.

The water inlet 6-2 of the weak electrical stimulation anoxic pool is arranged at an upper portion of an inner wall at one side of the weak electrical stimulation anoxic pool 10, and a water outlet 11-1 of the weak electrical stimulation anoxic pool is arranged at an upper portion of an inner wall at a side opposite to the one side. A water inlet 11-2 of the micro electrical stimulation anoxic pool is arranged at an upper portion of an inner wall at one side of the micro electrical stimulation anoxic pool 15, and a water outlet 16 of the micro electrical stimulation anoxic pool is arranged at an upper portion of an inner wall at a side opposite to the one side.

The water outlet 16 of the micro electrical stimulation anoxic pool is further connected with the water inlet 6-2 of the weak electrical stimulation anoxic pool through another pipeline.

The aerobic pool 5 and the weak electrical stimulation anoxic pool 10 are closely connected with each other, and share a same side wall; and the water outlet 6-1 of the aerobic pool also acts as the water inlet 6-2 of the weak electrical stimulation anoxic pool. The weak electrical stimulation anoxic pool 10 and the micro electrical stimulation anoxic pool 15 are closely connected with each other, and share a same side wall; and the water outlet 11-1 of the weak electrical stimulation anoxic pool also acts as the water inlet 11-2 of the micro electrical stimulation anoxic pool.

The sludge recycling outlet 19 is arranged at the bottom of the sedimentation pool 18.

In the aerobic sludge provided in the aerobic pool 5, nitrifying bacteria as dominant strain account for 60-80%; in the anoxic sludge provided in the weak electrical stimulation anoxic pool 10, denitrifying bacteria as dominant strain account for 60-80%; and in the anoxic sludge provided in the micro electrical stimulation anoxic pool 15, anammox bacteria as dominant strain account for 60-80%.

The above is only the preferred embodiments of the present disclosure, and is not construed as limiting the present disclosure. For those skilled in the art, the present disclosure may have various variations and changes. Any modifications, equivalent substitutions, improvements, etc. made within the spirit and principle of the present disclosure should be included in the scope of the present disclosure.

What is claimed is:

1. A bioaugmentation system for denitrification of landfill leachate, comprising a water collecting pool, an aerobic pool, a weak electrical stimulation anoxic pool, a micro electrical stimulation anoxic pool, and a sedimentation pool, all of which are connected in sequence,
wherein a uniform aeration device is arranged at a bottom of the aerobic pool;
a first stirring device and a second stirring device are arranged in the weak electrical stimulation anoxic pool and the micro electrical stimulation anoxic pool, respectively;
a sludge recycling outlet of the sedimentation pool is connected to a sludge recycling inlet of the aerobic pool through a first external pipeline;
a first electrode plate group that is connected to a first power supply is arranged in the weak electrical stimulation anoxic pool, a second electrode plate group that is connected to a second power supply is arranged in the micro electrical stimulation anoxic pool, and different voltages are applied according to a type of a sludge pool and actual conductivity in a landfill leachate treatment process; a voltage applied to the weak electrical stimulation anoxic pool is in a range of 1.0-2.0 V, and a voltage applied to the micro electrical stimulation anoxic pool is in a range of 0.2-0.6 V;
electrode plates in the first electrode plate group and the second electrode plate group each have a cuboid structure, a spacing between an anode and a cathode of each of the electrode plates is greater than 0.5 m, and cross-sectional area of a single electrode plate accounts for at least 50% of that of each of the weak electrical stimulation anoxic pool and the micro electrical stimulation anoxic pool;
the first power supply and the second power supply each are a direct-current (DC) regulated power supply;
the electrode plates in the first electrode plate group and the second electrode plate group each are a graphite electrode plate;
aerobic sludge with nitrifying bacteria as dominant strain is provided in the aerobic pool;
anoxic sludge with denitrifying bacteria as dominant strain is provided in the weak electrical stimulation anoxic pool; and anoxic sludge with anammox bacteria as dominant strain is provided in the micro electrical stimulation anoxic pool.

2. The bioaugmentation system for denitrification of landfill leachate as claimed in claim 1, wherein the spacing between an anode and a cathode in the first electrode plate group is in a range of 0.5-1.0 m, and the cross-sectional area of the single electrode plate accounts for 60-70% of that of each of the weak electrical stimulation anoxic pool and the micro electrical stimulation anoxic pool.

3. The bioaugmentation system for denitrification of landfill leachate as claimed in claim 1, wherein a DC voltage applied to each of the weak electrical stimulation anoxic pool and the micro electrical stimulation anoxic pool is jointly determined according to the type of the sludge pool and conductivity of the landfill leachate, specifically as follows:
for the weak electrical stimulation anoxic pool:
under the condition that the conductivity of the landfill leachate is less than 1×10⁴ μs/cm, the DC voltage applied is in a range of 1.6 V to 2.0 V, an electric field intensity is in a range of 1.6 V/m to 4.0 V/m, an anode potential is in a range of 0.8 V to 1.0 V, and a cathode potential is in a range of −0.8 V to −1.0 V; and
under the condition that the conductivity of the landfill leachate is greater than or equal to 1×10⁴ μs/cm, the DC voltage applied is in a range of 1.0 V to 1.6 V, the electric field intensity is in a range of 1.0 V/m to 3.2 V/m, the anode potential is in a range of 0.5 V to 0.8 V, and the cathode potential is in a range of −0.5 V to −0.8 V;
for the micro electrical stimulation anoxic pool:
under the condition that the conductivity of the landfill leachate is less than 1×10⁴ μs/cm, the DC voltage applied is in a range of 0.4 V to 0.6 V, an electric field intensity is in a range of 0.4 V/m to 1.2 V/m, an anode potential is in a range of 0.2 V to 0.3 V, and a cathode potential is in a range of −0.2 V to −0.3 V; and
under the condition that the conductivity of the landfill leachate is greater than or equal to 1×10⁴ μs/cm, the DC voltage applied is in a range of 0.2 V to 0.4 V, the electric field intensity is in a range of 0.2 V/m to 0.8 V/m, the anode potential is in a range of 0.1 V to 0.2 V, and the cathode potential is in a range of −0.1 V to −0.2 V.

4. The bioaugmentation system for denitrification of landfill leachate as claimed in claim 1, wherein the water collecting pool is provided with a water inlet of the water collecting pool at an upper portion and an emptying valve at a bottom.

5. The bioaugmentation system for denitrification of landfill leachate as claimed in claim 1, wherein the water collecting pool is connected with a water inlet of the aerobic pool through a water pump and a second external pipeline, and a water outlet of the aerobic pool is connected with a water inlet of the weak electrical stimulation anoxic pool through a pipeline.

6. The bioaugmentation system for denitrification of landfill leachate as claimed in claim 5, wherein the water inlet of the weak electrical stimulation anoxic pool is arranged at an upper portion of an inner wall at one side of the weak electrical stimulation anoxic pool, and a water outlet of the weak electrical stimulation anoxic pool is arranged at an upper portion of an inner wall at a side opposite to the one side; and
a water inlet of the micro electrical stimulation anoxic pool is arranged at an upper portion of an inner wall at one side of the micro electrical stimulation anoxic pool, and a water outlet of the micro electrical stimulation anoxic pool is arranged at an upper portion of an inner wall at a side opposite to the one side.

7. The bioaugmentation system for denitrification of landfill leachate as claimed in claim 6, wherein the water outlet of the micro electrical stimulation anoxic pool is further connected with the water inlet of the weak electrical stimulation anoxic pool through another pipeline.

8. The bioaugmentation system for denitrification of landfill leachate as claimed in claim 1, wherein the aerobic pool and the weak electrical stimulation anoxic pool are closely connected with each other, and share a same side wall; and a water outlet of the aerobic pool also acts as a water inlet of the weak electrical stimulation anoxic pool; and
the weak electrical stimulation anoxic pool and the micro electrical stimulation anoxic pool are closely connected with each other, and share a same side wall; and a water outlet of the weak electrical stimulation anoxic pool also acts as a water inlet of the micro electrical stimulation anoxic pool.

9. The bioaugmentation system for denitrification of landfill leachate as claimed in claim 1, wherein the sludge recycling outlet is arranged at a bottom of the sedimentation pool.

10. The bioaugmentation system for denitrification of landfill leachate as claimed in claim 1, wherein in the aerobic sludge provided in the aerobic pool, nitrifying bacteria as dominant strain account for 60-80%;
in the anoxic sludge provided in the weak electrical stimulation anoxic pool, denitrifying bacteria as dominant strain account for 60-80%; and
in the anoxic sludge provided in the micro electrical stimulation anoxic pool, anammox bacteria as dominant strain account for 60-80%.
